(19) United States
(12) Patent Application Publication
(10) Pub. No.: US 2024/0223685 A1
(43) Pub. Date: Jul. 4, 2024

(54) PARAMETER UPDATE FOR A CONNECTION EVENT

(71) Applicant: TEXAS INSTRUMENTS INCORPORATED, DALLAS, TX (US)

(72) Inventors: YARON ALPERT, Hod Hasharon (IL); MAXIM ALTSHUL, Kadima (IL)

(21) Appl. No.: 18/148,028

(22) Filed: Dec. 29, 2022

(51) Int. Cl. H04L 69/324; H04L 67/125

(52) U.S. Cl. CPC H04L 69/324; H04L 67/125; H04W 80/02

(57) ABSTRACT

A device configured to communicate wirelessly with an external device. The device includes a host configured to communicate with application software executing on the device. The device also includes a link layer configured to determine updated parameters for a connection event between the device and the external device. The link layer is also configured to transmit, responsive to the determining, a request characterizing the updated parameters for the connection event to a link layer of the external device. The link layer is configured to send an indication to the host characterizing the updated parameters for the connection event. The link layer adjusts the parameters of the connection event between the device and the external device to reflect the updated parameters responsive to the sending.

### TECHNICAL FIELD

This description relates to wireless communication between devices. More particularly, this description is related to updating parameters of a connection event for a connection between devices.

### BACKGROUND

Bluetooth Low Energy (BLE, Bluetooth LE or Bluetooth Smart) refers to a wireless personal area network protocol designed for applications in the healthcare, fitness, beacons, security, and home entertainment industries, for example. The BLE protocol includes a BLE protocol stack (or protocol stack) implemented in a controller and a host, with the controller including radio hardware, such as a transceiver. The host represents a protocol stack layer below an application that employs the BLE protocol for communication. The host includes network and transport protocols that enable applications to wirelessly communicate with peer devices in a standard and interoperable manner. The controller implements the link layer (LL) and the physical layer (PHY). The link layer provides low-level, “real-time” protocols that provide, in conjunction with the radio hardware of the PHY, standard-interoperable over-the-air communication. The link layer schedules packet reception and transmission, guarantees the delivery of data, and handles the link layer control procedures. The radio hardware implements analog and digital baseband functional blocks to enable firmware of the link layer to send and receive data in the 2.4 gigahertz (GHz) band of the radio spectrum. When two devices are connected, parameters of a connection event may need to be updated.

### SUMMARY

A first example relates to a device configured to communicate wirelessly with an external device. The device includes a host configured to communicate with application software executing on the device. The device also includes a link layer configured to determine updated parameters for a connection event between the device and the external device. The link layer is also configured to transmit, responsive to the determining, a request characterizing the updated parameters for the connection event to a link layer of the external device. The link layer is configured to send an indication to the host characterizing the updated parameters for the connection event. The link layer adjusts the parameters of the connection event between the device and the external device to reflect the updated parameters responsive to the sending.

A second example relates to a method for managing a connection event between a first device and a second device. The method includes determining, at a link layer of the first device, that parameters of the connection event between the first device and the second device are to be updated. The method also includes transmitting, responsive to the determining, a request characterizing updated parameters for the connection event to a link layer of the second device. The method further includes sending, by the link layer of the first device, an indication to a host of the first device, wherein the indication characterizes the updated parameters for the connection event. The method still further includes adjusting, by the link layer of the first device, the parameters of the connection event between the first device and the second device to reflect the updated parameters.

A third example relates to a device. The device includes a computing platform for executing an application configured to communicate with an application executing on an external device. The device includes a host configured to communicate with the application executing on the device. The device also includes a link layer. The link layer is configured to determine that parameters of a connection event between the device and an external device are to be updated. The link layer is also configured to transmit, responsive to the determining, an update parameters request characterizing updated parameters for the connection event to a link layer of the external device. The link layer is configured to send an update parameters indication to the host characterizing the updated parameters for the connection event. The link layer is also configured to adjust parameters of the connection event between the device and the external device to reflect the updated parameters responsive to the update parameters indication.

### BRIEF DESCRIPTION OF THE DRAWINGS

FIG. 1 is a block diagram illustrating an example network including devices that can implement fast signaling to update parameters of a connection event.

FIG. 2 is a sequence diagram illustrating example fast signaling to update parameters of a connection event for the devices illustrated in FIG. 1.

FIG. 3 is a sequence diagram illustrating example fast signaling to terminate a connection event between the devices illustrated in FIG. 1.

FIG. 4 is another sequence diagram illustrating example fast signaling to terminate a connection event between the devices illustrated in FIG. 1.

FIG. 5 is a sequence diagram illustrating example fast signaling to suspend a connection event between the devices illustrated in FIG. 1.

FIG. 6 is another sequence diagram illustrating example fast signaling to suspend a connection event of the devices of FIG. 1.

FIG. 7 is a sequence diagram illustrating example fast signaling to extend a current connection event between the devices of FIG. 1.

FIG. 8 is another sequence diagram illustrating example fast signaling to extend a current connection event between the devices of FIG. 1.

FIG. 9 is a flowchart of an example method for executing a fast signaling operation on connection events between a first device and a second device.

FIG. 10 illustrates an example of a computing system employable to implement the devices of FIG. 1.

### DETAILED DESCRIPTION

This description relates to systems and methods for executing a fast signaling operation to update one or more parameters for a connection event (or multiple connection events) for a connection between a first device and a second device. The first and second devices are implemented as computing platforms, such as hardware devices that execute software applications. The first and second devices include a PHY (e.g., a network transceiver) operating on a controller, such as a Bluetooth Low Energy (BLE) transceiver, a wireless battery management service (WBMS) transceiver or a sub-gigahertz (sub-GHz) for communicating via a personal area network (PAN), such as a BLE network, a WBMS network, or a sub-GHz network. The communication between the first device and the second device includes multiple connection events. A connection event refers to an instance of communication between the first device and the second device.

A controller of the first device and a controller of the second device both include a link layer that is configured to implement fast signaling. In operation of the fast signaling, the link layer of the first device determines that parameters for the connection event need updating. In various examples, the update to parameters of a particular communication event causes a termination of the connection event, a suspension of the connection events or an extension of the connection events. Fast signaling, as described herein, refers to an operation initiated by the link layer itself to update parameters of a connection event. Thus, by employing the system described, the link layer itself (e.g., the link layer of the first device or the second device) determines that the update to the parameters of the connection event is needed. That is, through fast signaling, the link layer avoids the need to receive a command from the corresponding host that the updated parameters need to be adjusted. In this manner, the parameters of the connection events are updated more quickly than other approaches.

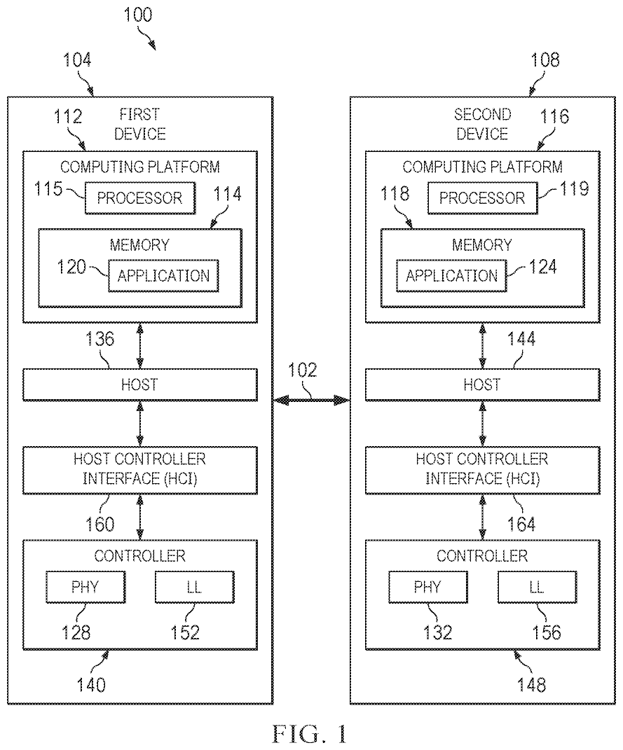

FIG. 1 is a block diagram illustrating an example network 100 (e.g., a system) including devices that can implement fast signaling to update parameters for a connection event. The network 100 employs fast signaling to update parameters of connection event of a communication link 102 between a first device 104 (alternatively referred to as device A) and a second device 108 (alternatively referred to as device B or an external device) on a network. The network 100 represents, in various examples, a PAN, such as a BLE network, a sub-GHz network or WBMS network. The communication link 102 includes multiple connection events, which include current connection events (present communication events that are active) and incoming connection events (future connection events to be activated).

In some examples, the first device 104 is implemented as a peripheral device, such as a wireless keyboard or a wireless mouse or trackpad. In other examples, the first device 104 is implemented as an Internet of Things (IOT) device, such as a remote control, a meter (e.g., a flow meter, an accelerometer), an appliance (e.g., a refrigerator, a washer/dryer), a control system (e.g., thermostat), etc. In some examples, the first device 104 is headless, indicating that the first device 104 is devoid of a user interface. That is, a headless device operates without human interaction. In any of these examples, the communication link 102 represents an intermittent wireless connection between the first device 104 and the second device 108. In these situations, connection events represent individual instances of communication over the communication link 102. For instance, consider a situation where the first device 104 is a refrigerator and the second device 108 represents a server. In this situation, the communication link 102 could represent a connection event established through pairing (using the BLE protocol) the first device 104 with the second device 108. Continuing with this example, a particular connection event could be established on the communication link 102 for the first device 104 (a refrigerator) to transmit a present measured temperature to the second device 108. After the transmission, the particular connection event terminates.

The first device 104 and the network includes a first computing platform 112. The computing platform 112 includes a non-transitory memory 114 (e.g., random access memory) for storing machine readable instructions, and a processor 115 (e.g., one or more processor cores) for accessing the non-transitory memory and executing the machine readable instructions. Thus, the non-transitory memory 114 is a computer readable medium. In some examples, the computing platform 112 of the first device 104 represents a controller with instructions embedded therein. In other examples, the computing platform 112 represents a computer, such as a smart phone, a tablet computer, a server, a desktop computer, etc. The second device 108 includes a second computing platform 116 that is implemented in a similar or different manner as the computing platform 112 of the first device 104. Thus, the computing platform 116 also includes a non-transitory memory 118 and a processor 119.

The computing platform 112 executes a first application 120 and the computing platform 116 executes a second application 124. The application 120 and the application 124 are implemented as application software. Moreover, the application 120 and the application 124 are configured to communicate through the communication link 102. The communication link 102 represents wireless communication that is established and maintained by a pair of PHYs, namely a first PHY 128 (alternatively referred to as a wireless network transceiver) operating on the first device 104 and a second PHY 132 (alternatively referred to as a wireless network transceiver) operating on the second device 108.

The PHY 128 and the PHY 132 are representative of hardware devices. The PHY 128 and the PHY 132 are PAN transceivers, such as BLE transceivers, sub-GHz network transceivers or WBMS transceivers. In any such example, the first device 104 also includes a first host 136 and a first controller 140. The PHY 128 is implemented on the controller 140. Similarly, the second device 108 includes a second host 144 and a second controller 148. The controller 148 implements the PHY 132. The host 136 and the host 144 includes network and transport protocols that enable the application 120 and the application 124 to communicate in an interoperable manner through the communication link 102.

The controller 140 implements a first link layer (LL) 152 and the controller 148 implements a second link layer 156. The link layer 152 and the link layer 156 provide a low-level, real-time protocol that provides standard-interoperable over-the-air communication in conjunction with radio hardware. The link layer 152 and the link layer 156 schedule packet reception and transmission, guarantees the delivery of data and handles the link layer control procedures for the controller 140 and the controller 148, respectively.

In some examples, transceiver components for the first device 104 are implemented with a single integrated circuit (IC) chip. In these examples, the host 136 and the controller 140 are integrated on the IC chip embedded in the first device 104. Similarly, in some examples, transceiver components for the second device 108 are implemented with a single IC chip. In such examples, the host 144 and the controller 148 are integrated on a single IC chip embedded in the second device 108.

Alternatively, the transceiver components of the first device 104 and/or the second device 108 are implemented with a pair of respective IC chips (e.g., a first and second IC chip of the first device 104 and/or a first and second IC chip of the second device 108). In these examples, the host 136 is implemented on a first IC chip in a respective pair of IC chips embedded in the first device 104. Also, the controller 140 is implemented on a second IC chip of the respective pair of IC chips embedded in the first device 104. In these situations, the first device 104 includes a first host controller interface (HCI) 160 to facilitate communication between the host 136 and the controller 140 and the second controller 148 includes a second HCI 164 to facilitate communication between the host 144 and the controller 148.

As noted, in some examples, the first device 104 and the second device 108 employ the BLE protocol to establish and maintain the communication link 102. In such situations, the BLE protocol defines an HCI layer implemented by the HCI 160 and the HCI 164. The HCI layer of the first device 104 is a thin layer which transports commands and events between the host 136 and the controller 140. Similarly, the HCI layer of the second device 108 is a thin layer which transports commands and events between the host 144 and the controller 148. In some examples of a pure network processor application, the HCI layer is implemented through a transport protocol such as universal asynchronous receiver-transmitter (UART) or universal serial bus (USB), or a system on a chip (SoC) internal interface. The HCI layer defines commands that the host can send to the controller and the events that the host can expect in return, and also the format for user and protocol data that needs to go propagate through the air. The HCI layer ensures that different host and controller implementations communicate in a standard way.

The communication link 102 represents two-way communication between the PHY 128 and the PHY 132. Moreover, the communication link 102 is intermittent based on parameters of connection event. That is, during an interval of time that a connection event between the first device 104 and the second device 108 is active, the communication link 102 is active, allowing data to wirelessly flow between the application 120 and the application 124. Additionally, during an interval of time that the communication link 102 is suspended or terminated, data does not flow between the first device 104 and the second device 108.

The link layer 152 and the link layer 156 employ fast signaling to update connection events on the communication link 102. By employing the network 100 described, the link layer itself (e.g., the link layer 152 or the link layer 156) determines that the update to the parameters of the connection event is needed. That is, through fast signaling, the link layer 152 and the link layer 152 avoid the need to receive a command from the corresponding host (e.g., the host 136 or the host 144) that the parameters need to be adjusted. In this manner, the parameters of the connection events are updated more quickly than other approaches.

In the example illustrated, for simplicity of explanation, components such as the hosts 136, 144, the HCIs 164 and the controllers 140 and 148 are represented as components external to the non-transitory memories 114 and 118. However, in some examples, the hosts 136, 144, the HCIs 164 and the controllers 140 and 148 are BLE stack components that are also implemented in memory or employ memory of the first device 104 and the second device 108, which may be the same or different memory than the non-transitory memories 140 and 148. Stated differently, in various examples, the components of the BLE stack, including the hosts 136, 144, the HCIs 164 and the controllers 140 and 148 are implemented as hardware, software or a combination thereof.

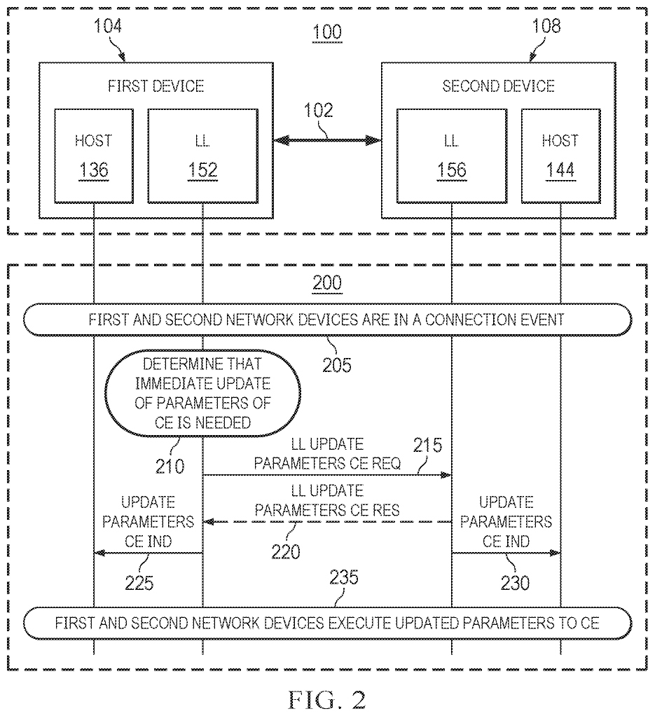

FIGS. 2-8 illustrate examples of sequence diagrams of the network 100 for managing the communication link 102 of FIG. 1. For simplicity, FIGS. 1-8 employ the same reference numbers to denote the same structures.

More particularly, FIG. 2 is a sequence diagram 200 illustrating fast signaling to update parameters of a connection event between the first device 104 and the second device 108 of FIG. 1. The host 136 and the link layer 152 of the first device 104 as well as the host 144 and the link layer 156 of the second device 108 execute a method for updating parameters of connection event.

At 205, the first device 104 and the second device 108 are in a connection event(s) (CE), which include current connection events and incoming connection events. At 205, the current connection events between the first device 104 and the second device 108 are active. Additionally, at 205 there are incoming communication events that will be activated in the future, such that the application 120 and the second application 124 are able to wirelessly communicate through the communication link 102. The connection event has a predefined interval of time, such that at the end of the interval of time, the connection event is deactivated. The duration of the predefined interval of time (e.g., a parameter of the connection event) is defined by the device (e.g., the first device 104 or the second device 108) that requested the activation of a particular connection event.

At 210, the link layer 152 determines that parameters of the connection event are to be updated in a fast signaling operation. The determination can be made, for example, based on factors such as overlap of other signals overlapping or interfering with the current, an incoming connection event, a need to transmit additional data through the communication link 102, etc.

In a first example, the link layer 152 determines that a second communication link is needed between the first device 104 and another device. In this situation, the link layer 152 determines that the connection event between the first device 104 and the second device 108 should be terminated or suspended. Alternatively, in a second example, the link layer 152 determines that a block of data needed to be transmitted over the communication link 102 will not be able to be fully transmitted during the interval of time defined for the connection event. In this situation, the link layer 152 determines that the connection event should be extended for a duration of time. In any such situation, the host 136 is not air link synchronized, such that the host 136 does not need to monitor the connection event. Instead, the fast signaling executed by the link layer 152 is focused on modifying the air synchronized connection events based on the link condition and specific metrics for key performance indicators of the connection events, including but not limited to a received signal strength indicator (RSSI), channel state information (CIS), performance packet error rate (PER), etc. to determine that the fast signaling operation is to be executed.

At 215, the link layer 152 transmits an update parameters of the connection event request of the communication link 102 (LL UPDATE PARAMETERS CE REQ) to the link layer 156. The update parameters of the connection event request includes data characterizing the updated parameters for the connection event. At 220, the link layer 156 transmits a response to the updated parameters of the connection event request (LL UPDATE PARAMETERS CE RES). In some examples, the response to the updated parameters of the connection event is included. In these examples, this response can include data for negotiating a modification to the updated parameters for the connection event characterized in the request. Moreover, in some examples, the response to the updated parameters of the connection event is omitted. In these situations, a simple acknowledgement (ACK) of receipt of the update parameters of the connection event request is transmitted from the link layer 156 to the link layer 152.

At 225, the link layer 152 sends the host 136 an update parameters of the connection event indication (UPDATE PARAMETERS CE IND). Similarly, at 230, the link layer 156 sends the host 144 an update parameters of the connection event indication (UPDATE PARAMETERS CE IND).

At 235, the link layer 152 and the link layer 156 adjust/update the connection event is executed to reflect the updated parameters, such that status of the connection event is changed. As noted, in some examples, the connection event are terminated or suspended for an interval of time. In other examples, the connection event are extended for a duration of time. By using fast signaling, as explained herein, the link layer 152 itself makes the determination that the parameters or the connection event are to be updated. That is, the link layer 152 does not need to receive a command from another layer of a protocol stack, such as the host 136 to initiate the updating.

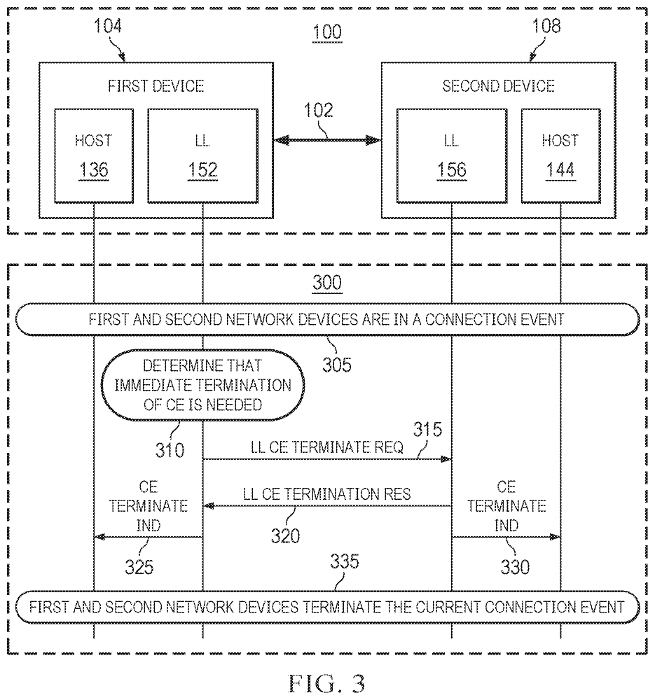

FIG. 3 is a sequence diagram 300 illustrating example fast signaling to terminate connection event between the first device 104 and the second device 108 of FIG. 1. In the sequence diagram 300, at 305, the first device 104 and the second device 108 are in a connection event(s) (CE). At 310, the link layer 152 determines that parameters of the connection event are to be updated in a fast signaling operation to terminate the connection event. The determination can be made, for example based on factors such as overlap of other signals overlapping or interfering with the connection event. For instance, in the sequence diagram 300, the link layer 152 determines that a second link is needed between the first device 104 and another device. In this situation, the link layer 152 determines that the connection event between the first device 104 and the second device 108 should be terminated.

At 315, the link layer 152 provides the link layer 156 with a terminate connection event request (LL CE TERMINATE REQ). The terminate the connection event request includes data indicating that the connection event are to be terminated at a particular time (e.g., immediately, such as within 100 milliseconds or less). At 320, the link layer 156 provides a response to the terminate connection event (LL CE TERMINATION RES). This response can include data for negotiating a modification to the time that the connection event are to be terminated, for example.

At 325, the link layer 152 sends the host 136 a connection event termination indication (CE TERMINATE IND). Similarly, at 330, the link layer 156 sends the host 144 a connection event termination indication (CE TERMINATE IND). At 335, the link layer 152 and the link layer 156 terminate the connection event for the first device 104 and the second device 108 such that the connection event is severed. Thus, in response to the operation at 335, the application 120 and the application 124 cannot wirelessly communicate until the connection event is re-established.

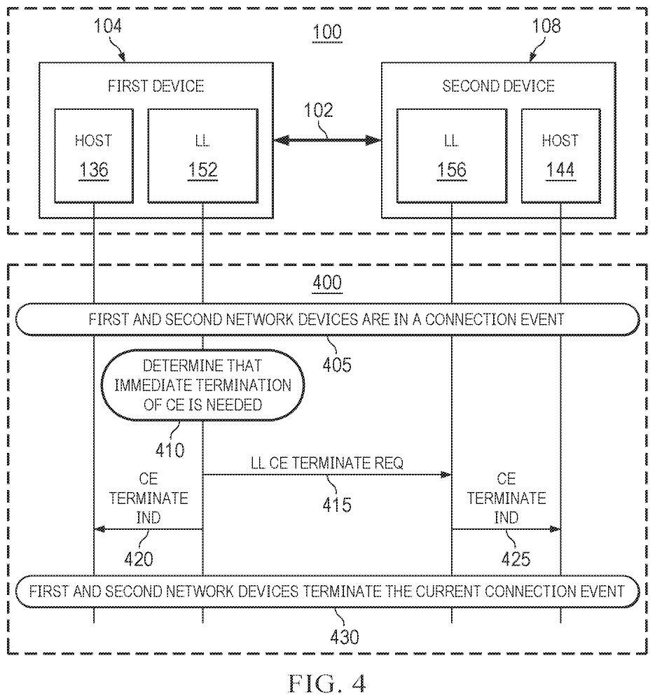

FIG. 4 is another sequence diagram 400 illustrating example fast signaling to terminate connection event between the devices illustrated in FIG. 1. More specifically, in some examples, the device of FIG. 1 terminate a current connection event immediately (e.g., within several milliseconds before the current connection event termination time), which is also referred to as an early termination. Additionally or alternatively, the network 100 is configured to terminate an incoming connection event (or multiple connection events) such that the incoming connection event is skipped. In the sequence diagram 400, at 405, the first device 104 and the second device 108 are in a connection event(s) (CE).

At 410, the link layer 152 determines that parameters of the connection event are to be updated in a fast signaling operation to terminate the connection event. The determination can be made, for example based on factors such as other signals overlapping or interfering with the connection event. For instance, in the sequence diagram 400, the link layer 152 determines that a second connection event is needed between the first device 104 and another device. In this situation, the link layer 152 determines that the connection event between the first device 104 and the second device 108 should be terminated.

At 415, the link layer 152 provides the link layer 156 with a terminate connection event request (LL CE TERMINATE REQ). The terminate connection event request includes data indicating that the connection event are to be terminated at a particular time (e.g., immediately). At 420, the link layer 152 provides the host 136 with a connection event termination indication (CE TERMINATE IND). Similarly, at 425, the link layer 156 sends the host 144 a connection event termination indication (CE TERMINATE IND). At 430, the link layer 152 and the link layer 156 terminate the connection event for the first device 104 and the second device 108 such that the connection event is severed. Thus, in response to the operation at 430, the application 120 and the application 124 cannot wirelessly communicate until the connection event is re-established.

In comparison to the sequence diagram 300 of FIG. 3, in the sequence diagram 400 of FIG. 4, the link layer 156 does not provide the response to the terminate connection event connection event request. Instead, in some examples, the link layer 156 provides a simple acknowledgement (ACK) of receipt in response to the termination of the connection event request. By omitting the response to the terminate connection event request, the sequence diagram 400 is executed faster than the sequence diagram 300. However, the controller 148 is not provided the opportunity to negotiate the termination of the connection event.

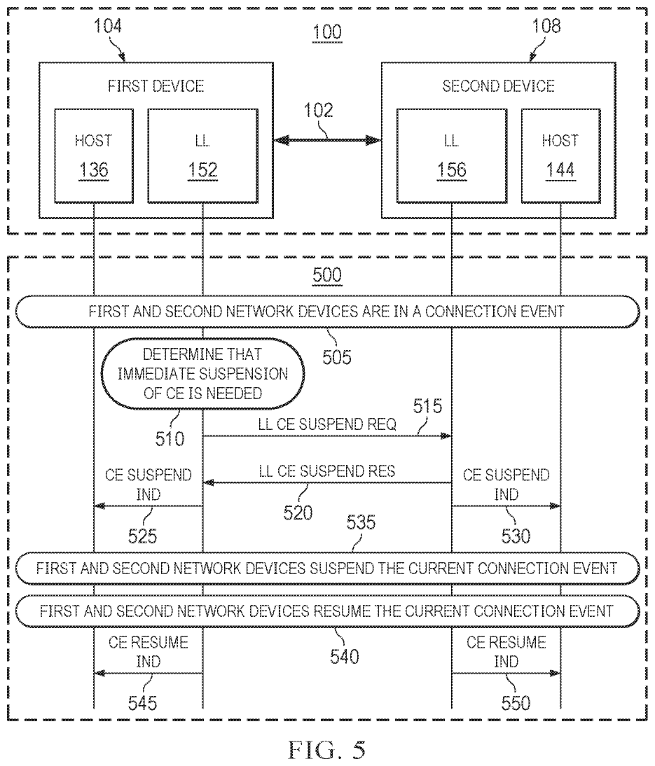

FIG. 5 is a sequence diagram 500 illustrating example fast signaling to suspend connection event between the first device 104 and the second device 108 of FIG. 1. More specifically, by suspending a current connection event, the current connection event is made inactive for a pre-defined suspension time interval. The duration for the pre-defined suspension time interval is defined in the parameters for the corresponding connection event. Additionally or alternatively, the network 100 is configured to suspend an incoming connection event (or multiple connection events) such that the incoming connection event is inactive at the time of the incoming connection event.

In the sequence diagram 500, at 505, the first device 104 and the second device 108 are in a connection event(s) (CE). At 510, the link layer 152 determines that parameters of the connection event are to be updated in a fast signaling operation to terminate the connection event. The determination can be made, for example based on factors such as other signals overlapping or interfering with the connection event. For instance, in the sequence diagram 500, the link layer 152 determines that a second connection event is needed between the first device 104 and another device. In this situation, the link layer 152 determines that the connection event between the first device 104 and the second device 108 should be suspended.

At 515, the link layer 152 provides the link layer 156 with a suspend connection event request (LL CE SUSPEND REQ). The suspend connection event request includes data indicating that the connection event is to be suspended for an interval of time (e.g., defining a start and end time for the suspension). At 520, the link layer 156 provides a response to the suspend connection event (LL CE SUSPEND RES). This response can include data for negotiating a modification to the interval of time that the connection event is to be suspended, for example.

At 525, the link layer 152 sends the host 136 a connection event suspension indication (CE SUSPEND IND). Similarly, at 530, the link layer 156 sends the host 144 a connection event suspension indication (CE SUSPEND IND). At 535, the link layer 152 and the link layer 156 suspend the connection event for the first device 104 and the second device 108 such that the connection event is severed. Thus, in response to the operation at 535, the application 120 and the application 124 cannot wirelessly communicate. After the interval of time specified by the link layer 152 has expired, at 540, the link layer 152 and the link layer 156 resume the connection event. At 545, the link layer 152 sends the host 136 a connection event resumed indication (CE RESUME IND). Similarly, at 550, the link layer 156 sends the host 144 a connection event resume indication (CE RESUME IND).

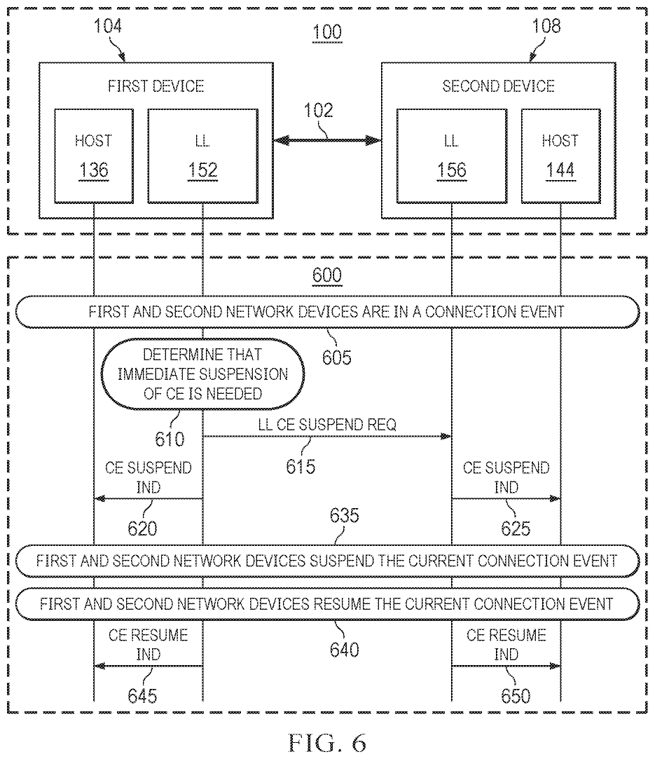

FIG. 6 is another sequence diagram 600 illustrating example fast signaling to suspend connection event between the first device 104 and the second device 108 of FIG. 1. In the sequence diagram 600, at 605, the first device 104 and the second device 108 are in a connection event(s) (CE). At 610, the link layer 152 determines that parameters of the connection event are to be updated in a fast signaling operation to suspend the connection event. The determination can be made, for example based on factors such as other signals overlapping or interfering with the connection event for an interval of time. For instance, in the sequence diagram 600, the link layer 152 determines that a second connection event is needed between the first device 104 and another device for an interval of time. In this situation, the link layer 152 determines that the connection event between the first device 104 and the second device 108 should be suspended.

At 615, the link layer 152 provides the link layer 156 with a suspend connection event request (LL CE SUSPEND REQ). The suspend connection event request includes data indicating that the connection event is to be suspended for an interval of time (e.g., defining a start and end time for the suspension).

At 625, the link layer 152 sends the host 136 a connection event suspension indication (CE SUSPEND IND). Similarly, at 630, the link layer 156 sends the host 144 a connection event suspension indication (CE SUSPEND IND). At 635, the link layer 152 and the link layer 156 suspend the connection event for the first device 104 and the second device 108 such that the connection event is severed. Thus, in response to the operation at 635, the application 120 and the application 124 cannot wirelessly communicate. After the interval of time specified by the link layer 152 has expired, at 640, the link layer 152 and the link layer 156 resume the connection event. At 645, the link layer 152 sends the host 136 a connection event resumed indication (CE RESUME IND). Similarly, at 650, the link layer 156 sends the host 144 a connection event resume indication (CE RESUME IND).

In comparison to the sequence diagram 500 of FIG. 5, in the sequence diagram 600 of FIG. 6, the link layer 156 does not provide the response to the suspend connection event request. Instead, in some examples, the link layer 156 provides a simple acknowledgement (ACK) of receipt in response to the suspend connection event. By omitting the response to the terminate connection event request, the sequence diagram 600 is executed faster than the sequence diagram 400. However, the PHY 132 is not provided the opportunity to negotiate the suspension of the connection event and/or modify the parameters (e.g., the interval of time) related to the suspension.

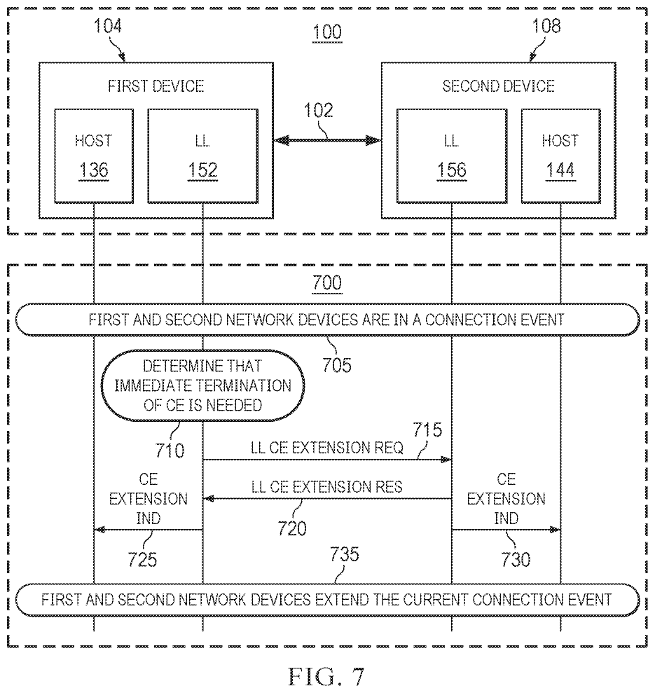

FIG. 7 is a sequence diagram 700 illustrating example signaling to extend a current connection event between the first device 104 and the second device 108 of FIG. 1. In the sequence diagram 700, at 705, the first device 104 and the second device 108 are in a connection event(s) (CE). At 710, the link layer 152 determines that parameters of the connection event are to be updated in a fast signaling operation to extend the connection event for the duration of time. The determination can be made, for example based on factors such as bandwidth needs to transmit a data block. For instance, in the sequence diagram 700, the link layer 152 determines that additional data needs to be transferred between the first device 104 and the second device 108 than is allowed by the connection event. Thus, in this situation, the link layer 152 determines that the connection event between the first device 104 and the second device 108 should be extended.

At 715, the link layer 152 provides the link layer 156 with an extend connection event request (LL CE EXTENSION REQ). The extend connection event request includes data indicating that the connection event is to be extended for a particular duration of time. That is, a deactivation time for the connection event is delayed. At 720, the link layer 156 provides a response to the extend connection event (LL CE EXTENSION RES). This response can include data for negotiating a modification to the duration of the extension, for example.

At 725, the link layer 152 sends the host 136 a connection event extension indication (CE EXTENSION IND). Similarly, at 730, the link layer 156 sends the host 144 a connection event extension indication (CE EXTENSION IND). At 735, the link layer 152 and the link layer 156 extends the connection event for the first device 104 and the second device 108 such that the connection event is extended for the duration of time specified by the link layer 152.

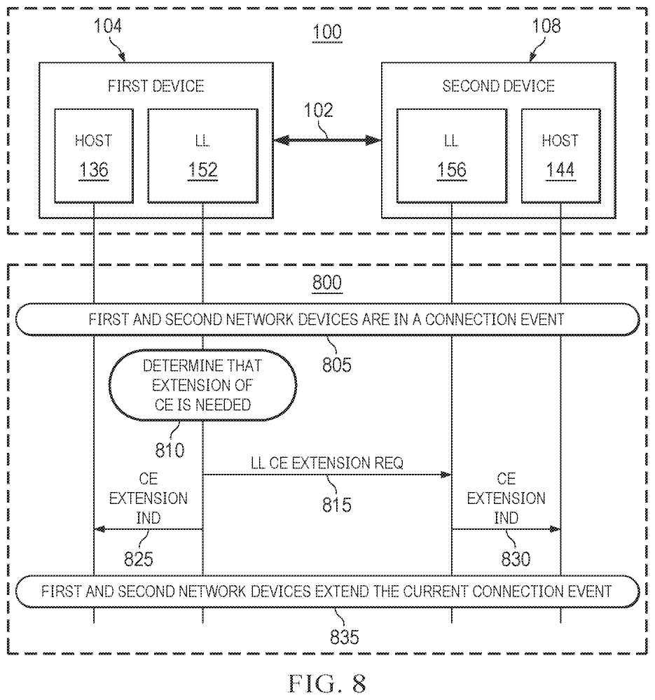

FIG. 8 is another sequence diagram 800 illustrating example fast signaling to extend a current connection event between the first device 104 and the second device 108 of FIG. 1. In the sequence diagram 800, at 805, the first device 104 and the second device 108 are in a connection event(s) (CE). At 810, the link layer 152 determines that parameters of the connection event are to be updated in a fast signaling operation to extend the connection event for a duration of time. The determination can be made, for example based on factors such as bandwidth needed to transmit a data block. For instance, in the sequence diagram 800, the link layer 152 determines that additional data needs to be transferred between the first device 104 and the second device 108 than is allowed by the connection event. Thus, in this situation, the link layer 152 determines that the connection event between the first device 104 and the second device 108 should be extended.

At 815, the link layer 152 provides the link layer 156 with an extend connection event request (LL CE EXTENSION REQ). The extend connection event request includes data indicating that the connection event is to be extended for a particular duration of time. That is, a deactivation time for the connection event is delayed.

At 825, the link layer 152 sends the host 136 a connection event extension indication (CE EXTENSION IND). Similarly, at 830, the link layer 156 sends the host 144 a connection event extension indication (CE EXTENSION IND). At 835, the link layer 152 and the link layer 156 extend the connection event for the first device 104 and the second device 108 such that the connection event is extended for the duration specified by the link layer 152.

In comparison to the sequence diagram 700 of FIG. 7, in the sequence diagram 800 of FIG. 8, the link layer 156 does not provide the response to the extend event request. Instead, in some examples, the link layer 156 provides a simple acknowledgement (ACK) in response to the extend connection event request. By omitting the response to the extend connection event request, the sequence diagram 800 is executed faster than the sequence diagram 700. However, the controller 148 is not provided the opportunity to negotiate the extension of the connection event and/or modify the parameters (e.g., the duration of time) related to the extension.

Referring back to FIG. 1, as illustrated in FIGS. 2-8, the fast signaling operations that change the parameters of the connection event are initiated by the link layer 152 of the controller 140. In contrast, in other approaches, a host determines that an update to parameters of the connection event is needed, and provides a command to the link layer. By employing the network 100 of FIG. 1, the link layer itself (e.g., the link layer 152 or the link layer 156) makes the determination, thereby increasing the speed of execution. Moreover, in some examples, as illustrated in FIGS. 4, 6 and 8, the link layer 156 does not provide a response to the update parameters of the connection event request. Omitting this response can further accelerate the speed of execution of the fast signaling operations.

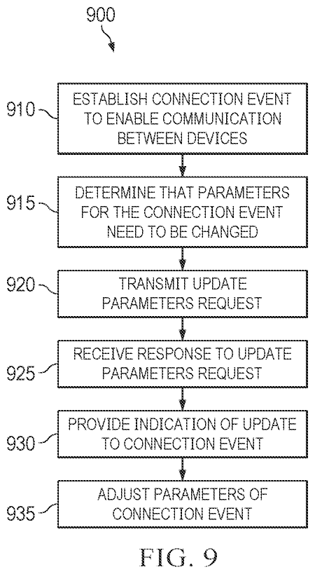

FIG. 9 illustrates a flowchart of an example method 900 for executing a fast signaling operation for a connection event between a first device (e.g., the first device 104 of FIG. 1) and a second device (e.g., the second device 108 of FIG. 1). The method 900 can be executed by the network 100 of FIG. 1.

At 910, the first and second devices establish the connection event, such that a first application (e.g., the application 120 of FIG. 1) executing on the first device communicates wirelessly with a second application (e.g., the application 124) executing on the second device.

The first device includes a host (e.g., the host 136 of FIG. 1) and a controller (e.g., the controller 140 of FIG. 1) with a PHY (e.g., the PHY 128 of FIG. 1). Similarly, the second device includes a host (e.g., the host 144 of FIG. 1) and a controller (e.g., the controller 148) with a PHY (e.g., the PHY 132 of FIG. 1). The controller of the first device and the second device include a link layer (e.g., the link layer 152 and the link layer 156, respectively) that is configured to implement fast signaling on the connection event.

At 915, the link layer of the first device determines that parameters for the connection event need to be updated. In various examples, the update of the parameters is termination of the connection event, a suspension of the connection event or an extension of the connection event. At 920, the link layer of the first device transmits an update parameters request to the link layer of the second device (e.g., wirelessly). At 925, the link layer of the first device receives a response to the update parameters request transmitted by the link layer of the second device.

At 930, the link layer of the first device and the link layer of the second device sends the host of the first device and the host of the second device, respectively, an indication of the update to the parameters of the connection event. At 935, the link layer of the first device and the link layer of the second device adjusts the parameters of the connection event. In some examples, this adjustment is a termination of the connection event. In other examples, this adjustment is a suspension of the connection event for an interval of time. In still other examples, this adjustment extends the connection event for a duration of time.

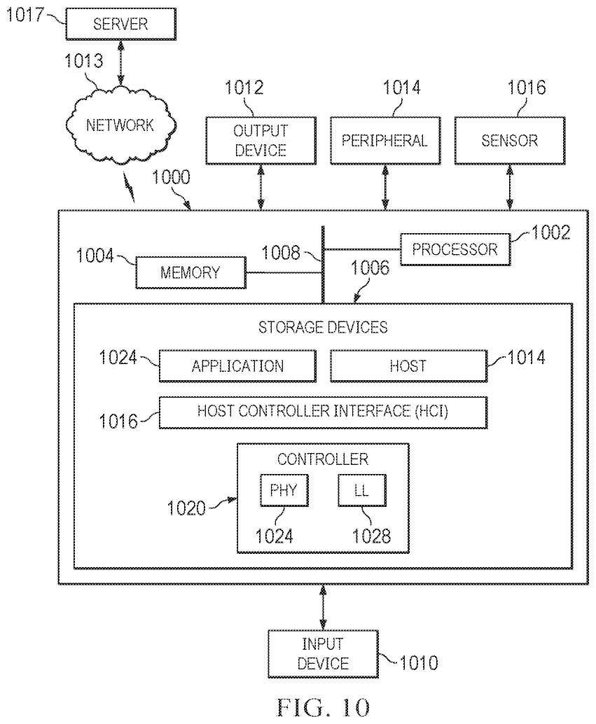

The examples herein may be implemented on virtually any type of computing system regardless of the platform being used. For example, the computing system may be one or more mobile devices (e.g., laptop computer, smart phone, personal digital assistant, tablet computer, or other mobile device), desktop computers, servers, blades in a server chassis, or any other type of computing device or devices that includes at least the minimum processing power, memory and input and output device(s) to perform one or more examples. As shown in FIG. 10, the computing system 1000 includes a computer processor 1002, associated memory 1004 (e.g., RAM, cache memory, flash memory, etc.), one or more storage devices 1006 (e.g., a solid state drive, a hard disk drive, an optical drive such as a compact disk (CD) drive or digital versatile disk (DVD) drive, a flash memory stick, etc.) and numerous other elements and functionalities. In the example illustrated, the memory 1004 and the storage devices 1006 are represented as separate memories, but in other examples, the storage devices 1006 and the memory 1004 are integrated. The computer processor 1002 may be an IC chip for processing instructions. For example, the computer processor may be one or more cores, or micro-cores of a processor. Components of the computing system 1000 communicate over a data bus 1008.

The computing system 1000 may also include an input device 1010, such as any combination of one or more of a touchscreen, keyboard, mouse, microphone, touchpad, electronic pen, or any other input device. Further, the computing system 1000 includes an output device 1012, such as one or more of a screen (e.g., light emitting diode (LED) display, an organic light emitting diode (OLED) display, a liquid crystal display (LCD), a plasma display, touchscreen, cathode ray tube (CRT) monitor, projector, or other display device), a printer, external storage, or any other output device. In some examples, such as a touch screen, the output device 1012 is the same physical device as the input device 1010. In other examples, the output device 1012 and the input device 1010 is implemented as separate physical devices. The computing system 1000 is connected to a network 1013 (e.g., LAN, a wide area network (WAN) such as the Internet, a mobile network, or any other type of network) via a network interface connection (not shown). In various examples, the input device 1010 and output device(s) 1012 are be connected locally and/or remotely (e.g., via the network 1013) to the computer processor 1002, the memory 1004 and/or the storage devices 1006. Many different types of computing systems exist, and the aforementioned input device 1010 and the output device 1012 can take other forms. The computing system 1000 can further include a peripheral 1014 and a sensor 1016 for interacting with the environment of the computing system 1000 in a manner described herein.

The storage devices 1006 include a host 1014 (e.g., the host 136 of FIG. 1), an HCI 1016 (e.g., the host 136 of FIG. 1) and a controller 1020 (e.g., the controller 140 of FIG. 1). The controller 1020 includes a PHY 1024 (e.g., the PHY 128 of FIG. 1) and a link layer 1028 (e.g., the link layer 152 of FIG. 1). Further, in the example illustrated, the host 1014, the HCI 1016 and the controller 1020 are illustrated as being implemented as software modules stored in the storage devices 1006. However, in other examples, the host 1014, the HCI 1016 and the controller 1020 are implemented as hardware components with embedded memories.

Software instructions in the form of computer readable program code to perform examples disclosed herein can be stored, in whole or in part, temporarily or permanently, on a non-transitory computer readable medium such as a CD, DVD, storage device, a diskette, a tape, flash memory, physical memory, or any other computer readable storage medium. Specifically, the software instructions can correspond to computer readable program code that when executed by a processor, is configured to perform operations disclosed herein. The computing system 1000 communicates with a server 1017 via the network 1013.

The storage devices 1006 also include an application 1024 (e.g., the application 120). The application 1024 is employable to communicate with an application executing on an external computing system. The host 1014 communicates with the application 1024 and the controller 1024 (e.g., through the HCI 1016) to enable wireless communication between the external computing system and the computing system 1000. This communication includes connection events with parameters that are updated by the link layer 1028. More specifically, the link layer 1028 includes machine readable instructions (e.g., embedded instructions) for modifying parameters of connection events using fast signaling operations described herein.

Modifications are possible in the described embodiments, and other embodiments are possible, within the scope of the claims.

What is claimed is:

1. A device configured to communicate wirelessly with an external device, the device comprising:
a host configured to communicate with application software executing on the device; and
a link layer configured to:
determine updated parameters for a connection event between the device and the external device;
transmit, responsive to the determining, a request characterizing the updated parameters for the connection event to a link layer of the external device; and
send an indication to the host characterizing the updated parameters for the connection event, in which the link layer adjusts the parameters of the connection event between the device and the external device to reflect the updated parameters responsive to the sending.

2. The device of claim 1, wherein the host and the link layer are integrated on an integrated circuit (IC) chip embedded in the device.

3. The device of claim 1, wherein the host is implemented on a first integrated circuit (IC) chip embedded in the device and the link layer is implemented on a second IC chip embedded in the device.

4. The device of claim 3, wherein the link layer implemented on the second IC chip further comprises a host controller interface (HCI) configured to manage communications between the host and the link layer.

5. The device of claim 1, wherein the PHY of the device is a Bluetooth low energy (BLE) transceiver.

6. The device of claim 1, wherein the PHY of the device is one of a wireless battery management (WBMS) transceiver and a sub-gigahertz (GHz) transceiver.

7. The device of claim 1, wherein the link layer of the device is configured to receive a response to the update parameters of the request.

8. The device of claim 1, wherein the link layer is configured to receive an acknowledgement of receipt of the update parameters of the request.

9. The device of claim 1, wherein the updated parameters specify an early termination of the connection event between the device and the external device.

10. The device of claim 1, wherein the updated parameters specify an extension of the connection event between the device and the external device for a duration of time.

11. The device of claim 1, wherein the updated parameters specify a suspension of the connection event between the device and the external device for an interval of time.

12. The device of claim 11, wherein the connection event between the device and the external device is resumed after the interval of time specified in the updated parameters.

13. A method for managing a connection event between a first device and a second device, the method comprising:
determining, at a link layer of the first device, that parameters of the connection event between the first device and the second device are to be updated;
transmitting, responsive to the determining, a request characterizing updated parameters for the connection event to a link layer of the second device;
sending, by the link layer of the first device, an indication to a host of the first device, wherein the indication characterizes the updated parameters for the connection event; and
adjusting, by the link layer of the first device, the parameters of the connection event between the first device and the second device to reflect the updated parameters.

14. The method of claim 13, wherein the host and the link layer of the first device are integrated on an integrated circuit (IC) chip embedded in the first device.

15. The method of claim 13, wherein the host of the first device is implemented on a first integrated circuit (IC) chip embedded in the first device, and wherein the link layer of the first device is implemented on a second IC chip embedded in the first device.

16. The method of claim 13, wherein the first device further comprises a controller comprising the link layer and a PHY.

17. The method of claim 13, wherein the link layer of the first device receives a response to the request.

18. The method of claim 13, wherein the updated parameters specify one of a termination of the connection event between the first device and the second device, a suspension for an interval of time of the connection event between the first device and the second device, or an extension for a duration of time for the connection event between the first device and the second device.

19. A device comprising:
a computing platform for executing an application configured to communicate with an application executing on an external device;
a host configured to communicate with the application executing on the device; and
a link layer configured to:
determine that parameters of a connection event between the device and an external device are to be updated;
transmit, responsive to the determining, a request characterizing updated parameters for the connection event to a link layer of the external device;
send an update parameters indication to the host characterizing the updated parameters for the connection event; and
adjust the parameters of the connection event between the device and the external device to reflect the updated parameters responsive to the update parameters indication.

20. The device of claim 19, wherein the device is a Bluetooth low energy (BLE) device.
